(19) United States
(12) Patent Application Publication
(10) Pub. No.: US 2015/0299480 A1
(43) Pub. Date: Oct. 22, 2015

(54) CLEAR MICROEMULSION STRIPPING FORMULATIONS

(71) Applicant: DOW GLOBAL TECHNOLOGIES LLC, Midland, MI (US)

(72) Inventors: Caroline Woelfle-Gupta, Lake Jackson, TX (US); Christopher J. Tucker, Midland, MI (US)

(21) Appl. No.: 14/437,639

(22) PCT Filed: Nov. 21, 2013
(86) PCT No.: PCT/US2013/071166

§ 371 Date: Apr. 22, 2015

Related U.S. Application Data
(60) Provisional application No. 61/737,375, filed on Dec. 14, 2012.

(51) Int. Cl. C09D 9/00; C11D 3/04; C11D 1/22; C11D 3/20; C11D 3/30

(52) U.S. Cl. CPC C09D 9/00; C11D 3/2068; C11D 3/30; C11D 1/22; C11D 3/044

(57) ABSTRACT

Described are stripper compositions, comprising a microemulsion, said microemulsion comprising greater than 20% glycol ether; a linear alkylbenzene sulfonate; at least two bases, one being an ethanolamine; and water, wherein the microemulsion is clear, and is stable between 5° C. and 45° C.; and wherein the stripper composition is capable of removing a removable coating.

### FIELD

The present invention relates to compositions for removing removable coatings, particularly to compositions for removing sacrificial floor coatings.

### BACKGROUND

Sacrificial floor coatings are functional coatings that are designed to protect a flooring substrate for a time, imparting durability and wear resistance, while improving its performance, such as controlling its slip resistance, and appearance, yet be removable with compositions referred to as “stripping formulations” or “strippers.” Strippers generally swell the coating to be removed, which, when coupled with the application of a mechanical force, act to remove the removable coating. Additionally, strippers usually contain an amine base which disrupts the metal crosslinks present in the removable coating, and thus enhances the efficiency of the floor stripper.

As may be appreciated, strippers are valued in the industry in proportion to their ease of removability. However, certain other benefits are increasingly becoming important, such as dilutability, stability, and clarity. Thus, what is needed are clear, stable, dilutable strippers with good removability.

### DETAILED DESCRIPTION

In one embodiment, the present invention provides stripper compositions, comprising a microemulsion, said microemulsion comprising greater than 20% glycol ether; a linear alkylbenzene sulfonate; at least two bases, one being an ethanolamine; and water, wherein the microemulsion is clear, and is stable between 5° C. and 45° C.; and wherein the stripper composition is capable of removing a removable coating.

“Stripper composition” refers to a composition that is capable of removing a removable coating. A composition is “capable of removing a removable coating” when after application, and scrubbing of the floor polish, the naked tile is clearly visible, and free of residual floor polish.

“Removable coating” refers to a covering that is applied to a floor substrate to enhance its appearance, scratch resistance, resistance to stains and liquids, etc. It is understood that ultra-durable compositions, such as polyurethanes and epoxies, are not intended to be embraced by the term “removable coating” for purposes of this specification. In one embodiment, the removable coating is an acrylic based removable coating.

“Microemulsion” refers to infinitely stable systems which do not phase separate, unless a change in factors such as composition, temperature or pressure is applied. Unlike emulsions which require high shear to form, microemulsions form spontaneously providing the right composition is attained. The size of the droplets formed within a microemulsion is usually smaller than 100 nm, while droplet sizes within an emulsion are usually larger than 1000 nm. As a result, emulsions are turbid, while microemulsions are single phase transparent systems, which are either completely clear, or have a slightly bluish color.

Whereas emulsions require high shear to be formed, in contrast, microemulsions are systems which form instantaneously upon mixing of the components. Simple shaking to mix the components together is enough to form a microemulsion, if the right composition is used. Methods of making microemulsions are well-known, and employ the use of a nonionic surfactant or an ionic surfactant, as well as mixtures of these. Systems based on nonionic surfactants are temperature sensitive, while systems based on ionic surfactants usually require a salt, and a co-solvent to form. Microemulsions can exist in equilibrium with an oil phase, a water phase, or both. Depending on the composition a single phase system can be obtain, which is highly desirable for commercial floor stripping applications.

In one embodiment, the greater than 20% glycol ether is selected from an ethylene oxide-based glycol ether, based on reacting ethylene oxide with varying chain alcohols or a propylene oxide-based glycol ether, based on reacting propylene oxide with varying chain alcohols, commercially available from The Dow Chemical Company, under the tradenames DOW E-Series Glycol Ethers or DOW P-Series Glycol Ethers respectively. Embodiments where more than one glycol ether is present are contemplated. In one embodiment, the glycol ether is ethylene glycol phenyl ether or propylene glycol phenyl ether, commercially available from The Dow Chemical Company, under the tradename DOWANOL. Preferably, the glycol ether is present in greater than 22%, more preferably greater than 23%, more preferably greater than 24%, and most preferably greater than 25%. The maximum concentration of glycol ether is 35%.

In one embodiment, the surfactant is linear alkylbenzene sulfonate (LAS). In this embodiment, the surfactant is present in the microemulsion in a range from greater than 3%, greater than 5%, about 7%, less than 9%, or less than 10%.

In one embodiment, the surfactant is hydroxymethyl stearate (HMS). In this embodiment, the surfactant is present in the microemulsion in a range from greater than 3%, greater than 5%, about 7%, less than 9%, or less than 10%.

In one embodiment, the bases are sodium hydroxide and monoethanolamine. In one embodiment, the bases are sodium hydroxide and monoisopropanolamine. The sodium hydroxide is present in an amount from 0.05% to about 1.5%. The ethanolamine is present from 0.05% to 7%, preferably less than 6.5%.

In one embodiment, the salt is an alkali halide, preferably sodium chloride. The salt is present in the microemulsion in a range from greater than 0.1%, greater than 0.24%, less than 0.8%, or less than 1%.

In one embodiment, the water is present in the microemulsion in a range from about at least 45% water, preferably at least 49% water, about 50%, less than 58%, or less than 65%.

Optionally, the microemulsion further comprises a co-solvent. To form a microemulsion with an anionic surfactant, a co-solvent is practically always needed. When present, the microemulsion contains at least 5%, preferably at least 10%, more preferably at least 15% co-solvent. A preferred co-solvent is butyl carbitol.

As the microemulsion is a single phase, it can be appreciated that with careful selection of components, some dilutions of the microemulsion will result in embodiments wherein the diluted stripper composition is in a single phase. Similarly, in some embodiments, the stripper composition is clear, or a translucent blue.

In use, the stripper composition is applied to a coated substrate, allowed to sit for a time, then the substrate is agitated, such as by brushing or scrubbing, to remove the coating.

### EXAMPLES

The following examples are for illustrative purposes only and are not intended to limit the scope of the present invention. All percentages are by weight unless otherwise specified.

### Example 1

Examples of microemulsions of the present invention suitable for stripping compositions are listed in TABLES 1A and 1B (in %):

TABLE 1A

| | Sample | Sample | Sample | Sample |
|---|---|---|---|---|
| | 1 | 2 | 3 | 4 |
| Ethylene Glycol Phenyl Ether | 26.9 | 25.5 | 26.4 | 26.0 |
| Methoxytriglycol | 12.0 | 11.4 | 11.8 | 11.6 |
| Sodium Hydroxymethyl Stearate | 7.2 | 6.8 | 7.1 | 6.98 |
| NaOH | 0.048 | 0.14 | 0.28 | 0.37 |
| Monoethanolamine | 0.96 | 1.82 | 2.83 | 3.26 |
| Sodium Chloride | 0.96 | 0.91 | 0.94 | 0.93 |
| DI Water | 51.93 | 53.43 | 50.65 | 50.86 |

TABLE 1B

| | Sample | Sample | Sample | Sample | Sample |
|---|---|---|---|---|---|
| | 5 | 6 | 7 | 8 | 9 |
| Ethylene Glycol Phenyl | 26.2 | 26.4 | 26.0 | 25.7 | 25.1 |
| Ether | | | | | |
| Methoxytriglycol | 16.4 | 16.5 | 16.3 | 16.0 | 15.7 |
| Sodium Dodecyl | 7.0 | 7.0 | 6.98 | 6.88 | 6.73 |
| Benzene Sulfonate | | | | | |
| NaOH | 0.09 | 0.28 | 0.37 | 0.46 | 0.63 |
| Monoethanolamine | 1.4 | 2.83 | 3.26 | 3.67 | 4.0 |
| Sodium Chloride | 0.37 | 0.38 | 0.37 | 0.37 | 0.36 |
| DI Water | 48.54 | 46.61 | 46.72 | 46.92 | 47.48 |

For microemulsions, the order of addition of the components or methods of mixing are not critical, since they do not require shear to form. In this example, components are mixed together in a vial with shaking.

### Example 2

Another example of a microemulsion of the present invention suitable for a stripping composition is listed in TABLE 2 (in %):

TABLE 2

| | Sample |
|---|---|
| | 10 |
| Ethylene Glycol Phenyl Ether | 17.06 |
| Diethylene Glycol Hexyl Ether | 10.69 |
| DOWFAX 2A1 Alkyldiphenyloxide Disulfonate | 6.32 |
| NaOH | 0.23 |
| Monoisopropylamine | 5.38 |
| NaCl | 0.34 |
| DI Water | 59.98 |

The microemulsion may be prepared as described in Example 1.

### Example 3

Examples of microemulsions of the present invention suitable for stripping compositions are listed in TABLE 3 (in %):

TABLE 3

| | Sample | Sample | Sample | Sample | Sample |
|---|---|---|---|---|---|
| | 11 | 12 | 13 | 14 | 15 |
| Propylene Glycol | 25 | 25 | 25 | 25 | 25 |
| Phenyl Ether | | | | | |
| Methoxytriglycol | 10 | 15 | 10 | 15 | 10 |
| Sodium Hydroxymethyl | 7.5 | 7.5 | 7.5 | 7.5 | 7.5 |
| Stearate | | | | | |
| NaOH | 0.25 | 0.25 | 0.25 | 0.25 | 0.25 |
| Monoethanolamine | 2 | 2 | 3.5 | 3.5 | 5 |
| DI Water | 55.25 | 50.25 | 53.75 | 48.75 | 52.25 |

The microemulsions may be prepared as described in Example 1.

### Example 4

To test the efficacy of stripping compositions of the present invention, two removable coating formulations were prepared, as described in TABLE 4 (in parts):

TABLE 4

| | Coating W | Coating X |
|---|---|---|
| Water | 934.72 | 1488.96 |
| SILFOAM ® SE-21 Defoamer | 0.64 | 1.6 |
| KATHON ® CG/ICP preservative (1.5%) | 0 | 2.24 |
| ACRYSOL ® 644 Acrylic copolymer (42%) | 87.68 | 0 |
| ABEX ® 18S Emulsifier (35%) | 0 | 16.0 |
| ZONYL ® FSJ Fluorosurfactant wetting | 32.0 | 30.4 |
| aid (1%) | | |
| DOWANOL ® DE Diethylene glycol | 196.8 | 128.0 |
| monoethyl ether | | |
| Tripropylene glycol methyl ether | 35.52 | 0 |
| KP-140 ® TBEP Tributoxy ethyl phosphate | 61.12 | 48.0 |
| RHOPLEX ® 1421 Zinc-crosslinked, | 1554.56 | 0 |
| modified acrylic polymer (38%) | | |
| CHEMREZ ® 30 Styrene-acrylic resin (30%) | 0 | 100.48 |
| DURAGREEN ® MF 1 Acrylic emulsion | 0 | 1222.4 |
| (40.5%) | | |
| EPOLENE ® E-43N Maleic anhydride | 138.56 | 75.52 |
| grafted polypropylene (40%) | | |
| A-C ® 325N Polyethylene Wax Emulsion | 158.4 | 86.4 |
| (35%) | | |
| Total Parts: | 3200 | 3200 |

The coatings are conventionally prepared.

### Coating of Tiles

Bare tiles obtained from Home Depot are cleaned with a stripping solution (GP forward+1% ammonia) combined with Ajax cleaner to remove the silicone release agent put on the tile by the tile manufacturer. Four coats of floor coating are applied to simulate real world conditions. These coats are applied with a gauze pad (Venture-#908294) with 2 mL of polish applied on top of the gauze pad. The pad is then carefully moved to cover the entire tile (first middle, then left to right, then top to bottom). Care is taken to avoid the formation of bubbles in the polish during application. A tack test is typically performed after the application of each coating to check the dryness of the coating before applying a new one. One coating typically takes 30 min to 1 hr to dry.

### Removal of Coatings

One of each of the sets of coated tiles from above was soaked for less than thirty seconds with the stripping compositions listed below, including FREEDOM® brand commercial stripper (Diversey Inc. Sturtevant, Wis. 53177 USA), diluted in a 1 to 4 ratio with DI water.

FREEDOM® floor stripper contains multiple reagents to swell the polymer film including: solvents, such as diethylene glycol phenyl ether, and ethylene glycol phenyl ether, amines such as monoethanolamine, and surfactants such as sodium xylene sulfonate.

The soaked tiles were then scrubbed for one minute at a rate of 50 strokes/min. Results are summarized in TABLE 5, in % removed:

TABLE 5

| | Coating W | Coating X |
|---|---|---|
| Sample 1 | 70 | 20 |
| Sample 2 | 70 | 30 |
| Sample 3 | 100 | 40 |
| Sample 4 | 100 | 10 |
| Sample 5 | 60 | 30 |
| Sample 6 | 80 | 40 |
| Sample 7 | 90 | 40 |
| Sample 8 | 95 | 35 |
| Sample 9 | 80 | 35 |
| Sample 10 | 100 | — |
| Sample 11 | — | 50 |
| Sample 12 | — | 45 |
| Sample 13 | — | 55 |
| Sample 14 | — | 50 |
| Sample 15 | — | 25 |
| Comparative | 45-60 | 25-40 |
| FREEDOM stripper | | |

### Example 5

To test the stability of stripping compositions of the present invention, Sample 10 (Example 2) was prepared and tested at 5° C., 20° C., 45° C., and upon dilution 1 to 4 with DI water at 45° C. Phase clarity was determined visually, then measured (Gray Scale) using a phase identification and characterization apparatus using blue, green, and red color detection, was 6, 5, 7, and 3, respectively, indicating that Sample 10 is clear at all the above temperatures, and even remained clear upon dilution.

Sample 2 (Example 1) was prepared and visually confirmed as clear, then tested upon dilution 1 to 4 with DI water at 45° C. Phase clarity (Gray scale), as measured above, was 2, indicating that Sample 2 remained clear upon dilution.

Sample 15 (Example 3) was prepared and visually confirmed as clear at 5° C., 20° C., 45° C., however, not upon dilution 1 to 4.

1. A stripper composition, comprising:
a microemulsion, said microemulsion comprising:
greater than 20% glycol ether;
a linear alkylbenzene sulfonate;
at least two bases, one being an ethanolamine; and
water, wherein the microemulsion is clear, and is stable between 5° C. and 45° C.; and
wherein the stripper composition is capable of removing a removable coating.

2. The stripper composition of claim 1, wherein the microemulsion further comprises a salt.

3. The stripper composition of claim 1, wherein the microemulsion further comprises a co-solvent.

4. The stripper composition of claim 1, wherein bases are sodium hydroxide and monoethanolamine.

5. The stripper composition of claim 1, wherein bases are sodium hydroxide and monoisopropanolamine.
